(19) United States
(12) Patent Application Publication
(10) Pub. No.: US 2026/0061616 A1
(43) Pub. Date: Mar. 5, 2026

(54) COOKING AND SERVING GENERAL PURPOSE ROBOT

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/312,094

(22) Filed: Aug. 27, 2025

Related U.S. Application Data
(60) Provisional application No. 63/688,646, filed on Aug. 29, 2024.

(51) Int. Cl. B25J 9/16; B25J 11/00; B25J 15/00

(52) U.S. Cl. CPC B25J 9/1679; B25J 11/0085; B25J 15/0019

(57) ABSTRACT

A method is described for a tidying robot to approach a storage device, such as a refrigerator or freezer, containing a food item, and perform a series of actions to remove the food item. The robot then transports the food item to either a cooking device or a serving location. The method may also adjust the operating conditions of the cooking device. The method may also include retrieving serving objects, such as plates and cutlery items from a storage location and transporting those serving objects to a serving location.

This application claims the benefit of U.S. provisional patent application Ser. No. 63/688,646, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

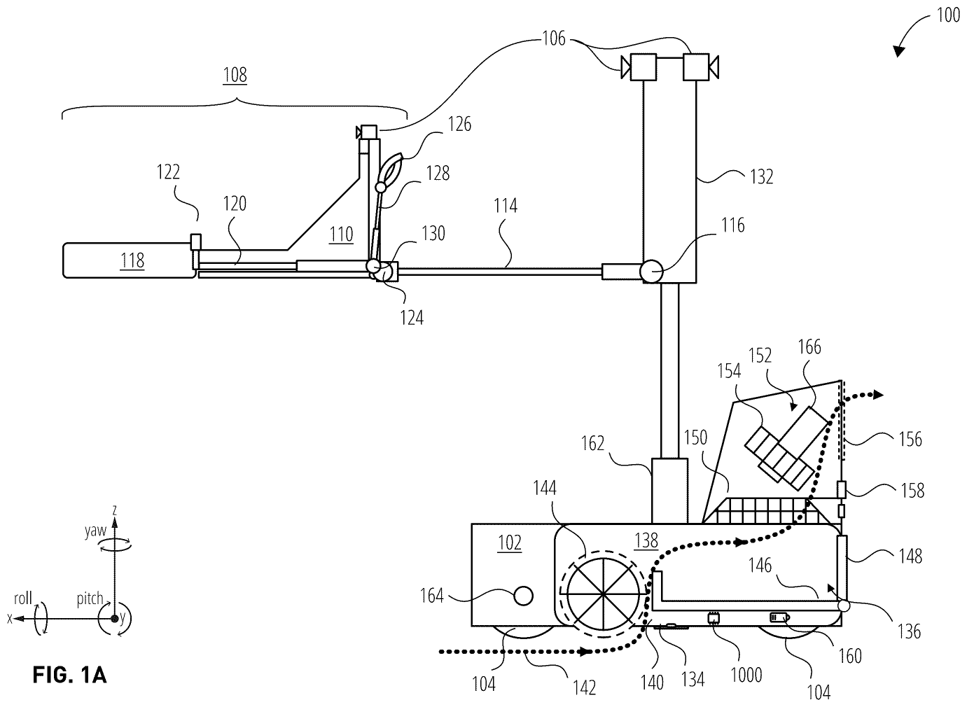

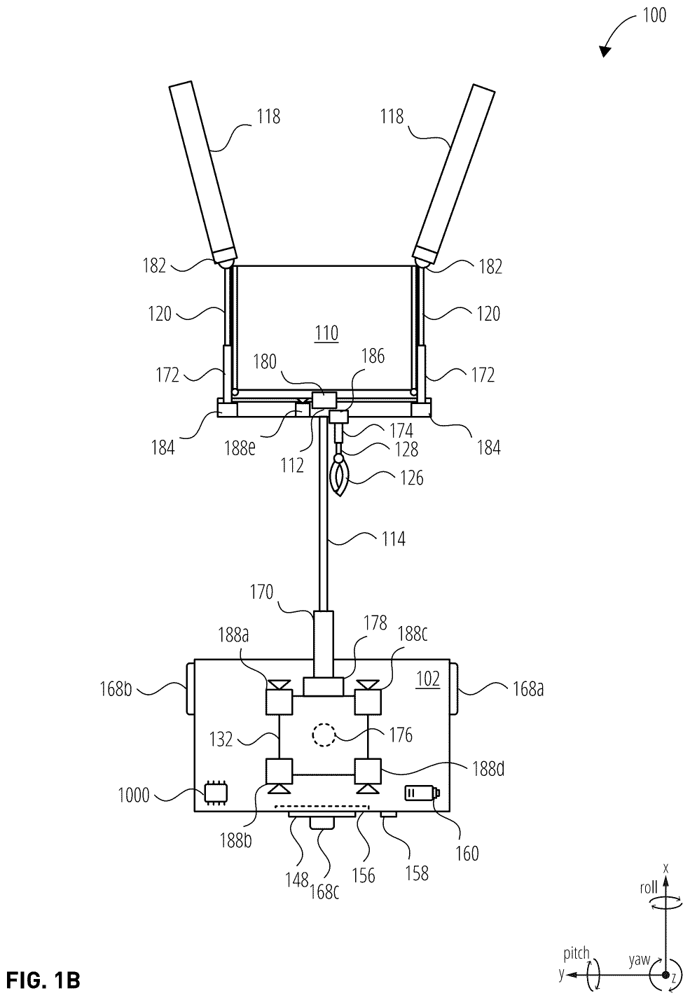

FIG. 1A and FIG. 1B illustrate a tidying robot 100 in accordance with one embodiment. FIG. 1A shows a side view and FIG. 1B shows a top view.

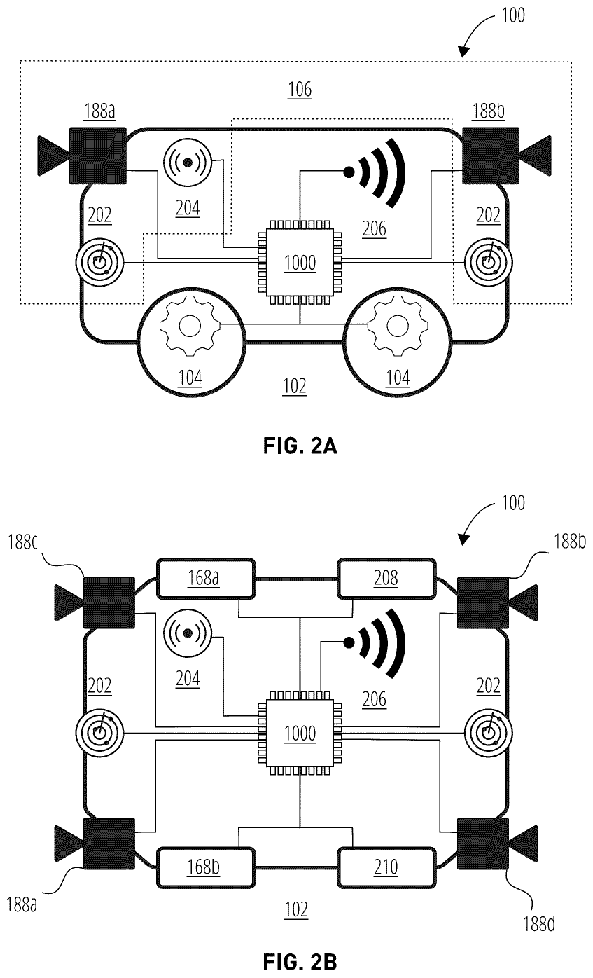

FIG. 2A and FIG. 2B illustrate a simplified side view and top view of a chassis 102 of the tidying robot 100, respectively.

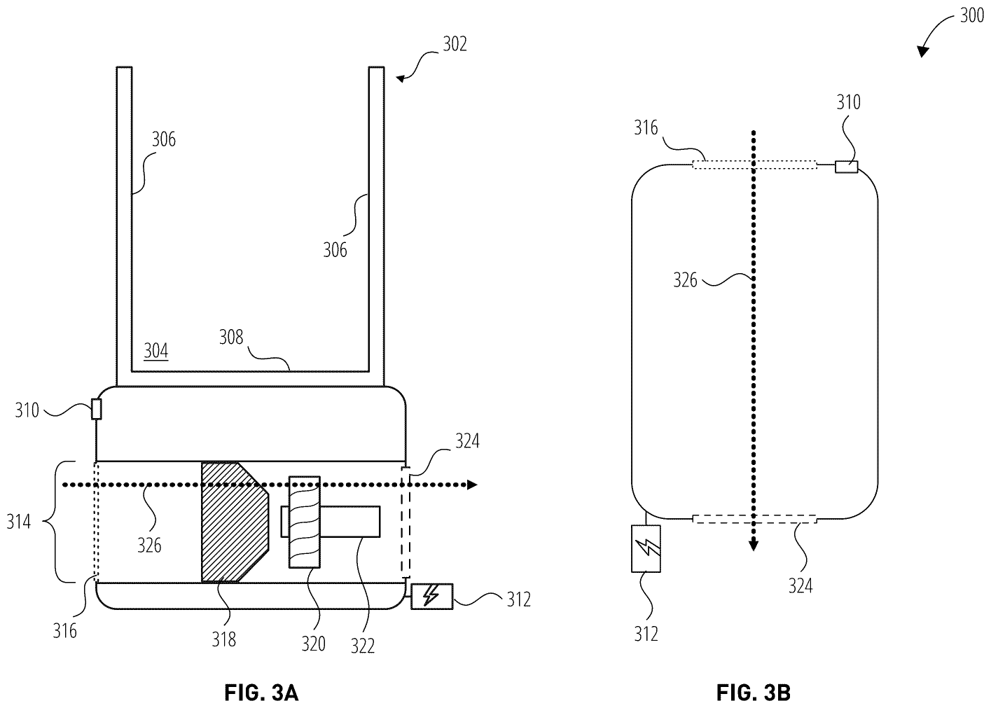

FIG. 3A and FIG. 3B illustrate a left side view and a top view of a base station 300, respectively, in accordance with one embodiment.

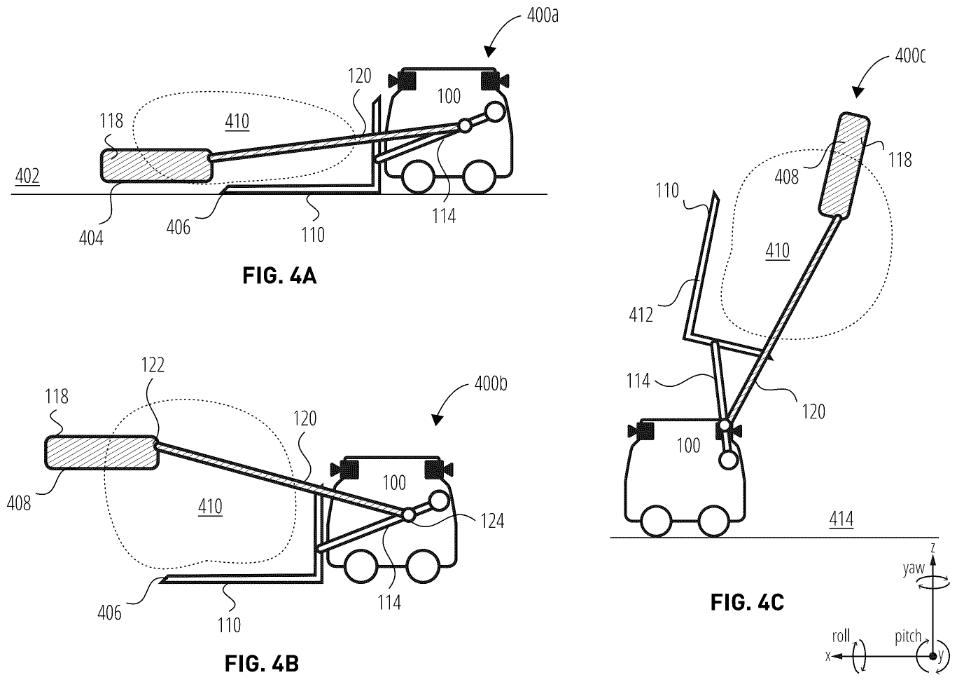

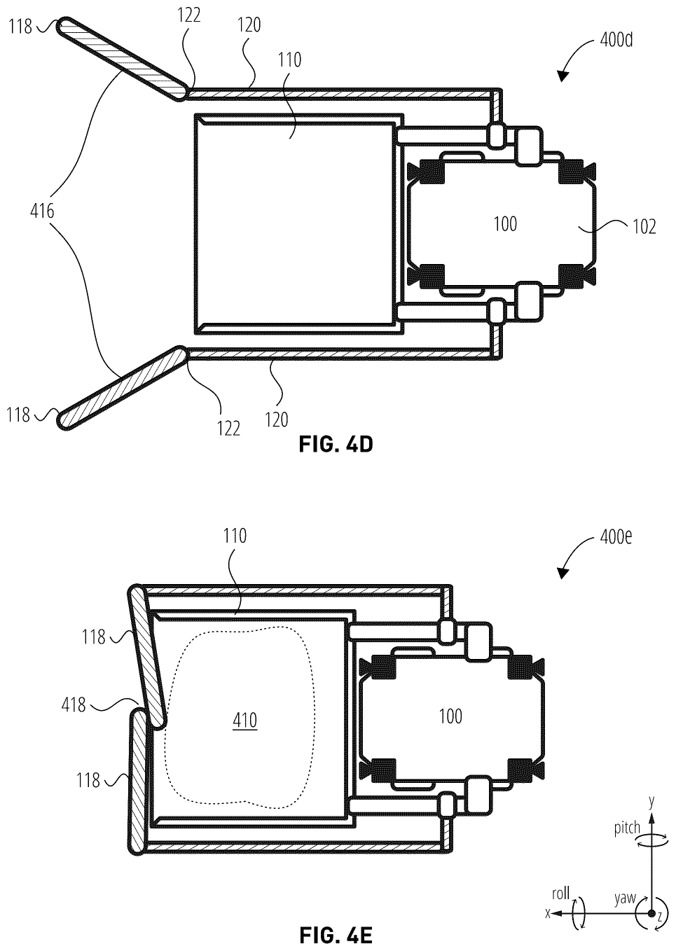

FIG. 4A illustrates a lowered scoop position and lowered pusher position 400a for the tidying robot 100 in accordance with one embodiment.

FIG. 4B illustrates a lowered scoop position and raised pusher position 400b for the tidying robot 100 in accordance with one embodiment.

FIG. 4C illustrates a raised scoop position and raised pusher position 400c for the tidying robot 100 in accordance with one embodiment.

FIG. 4D illustrates a tidying robot 100 with pusher pads extended 400d in accordance with one embodiment.

FIG. 4E illustrates a tidying robot 100 with pusher pads retracted 400e in accordance with one embodiment.

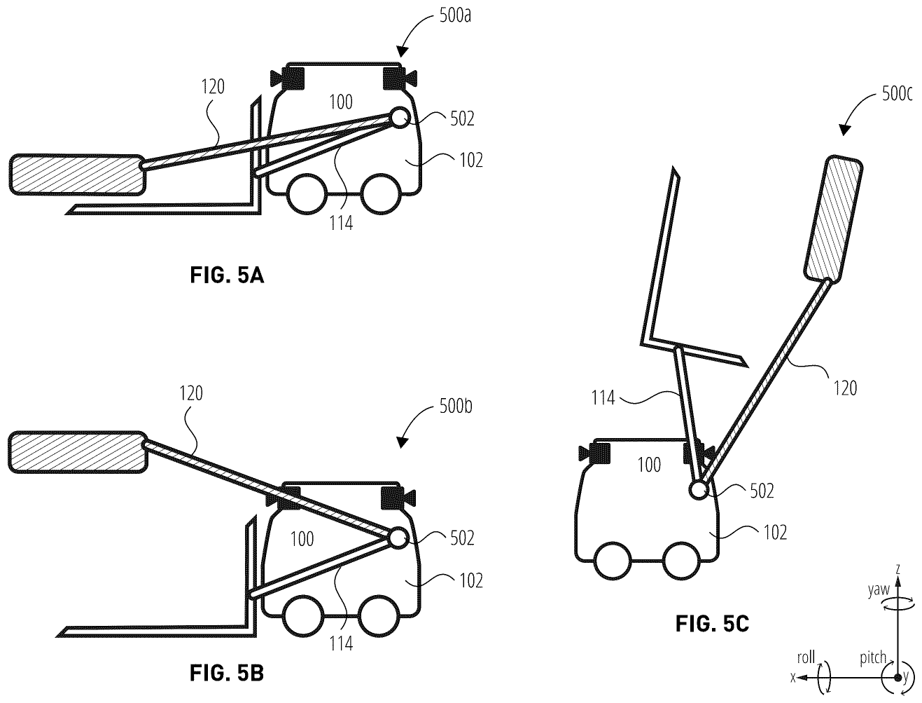

FIG. 5A illustrates a lowered scoop position and lowered pusher position 500a for the tidying robot 100 in accordance with one embodiment.

FIG. 5B illustrates a lowered scoop position and raised pusher position 500b for the tidying robot 100 in accordance with one embodiment.

FIG. 5C illustrates a raised scoop position and raised pusher position 500c for the tidying robot 100 in accordance with one embodiment.

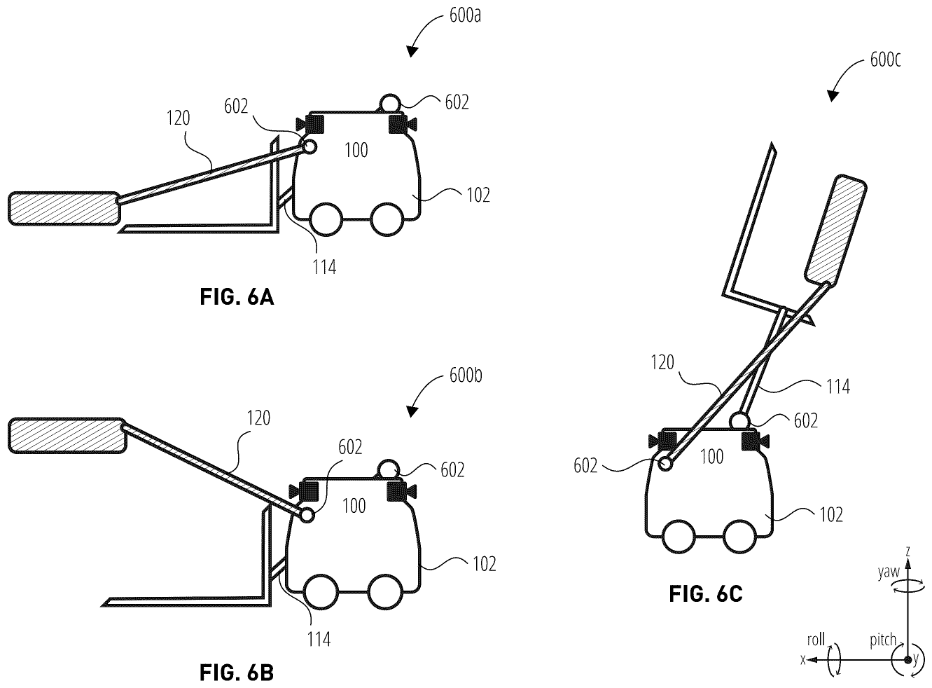

FIG. 6A illustrates a lowered scoop position and lowered pusher position 600a for the tidying robot 100 in accordance with one embodiment.

FIG. 6B illustrates a lowered scoop position and raised pusher position 600b for the tidying robot 100 in accordance with one embodiment.

FIG. 6C illustrates a raised scoop position and raised pusher position 600c for the tidying robot 100 in accordance with one embodiment.

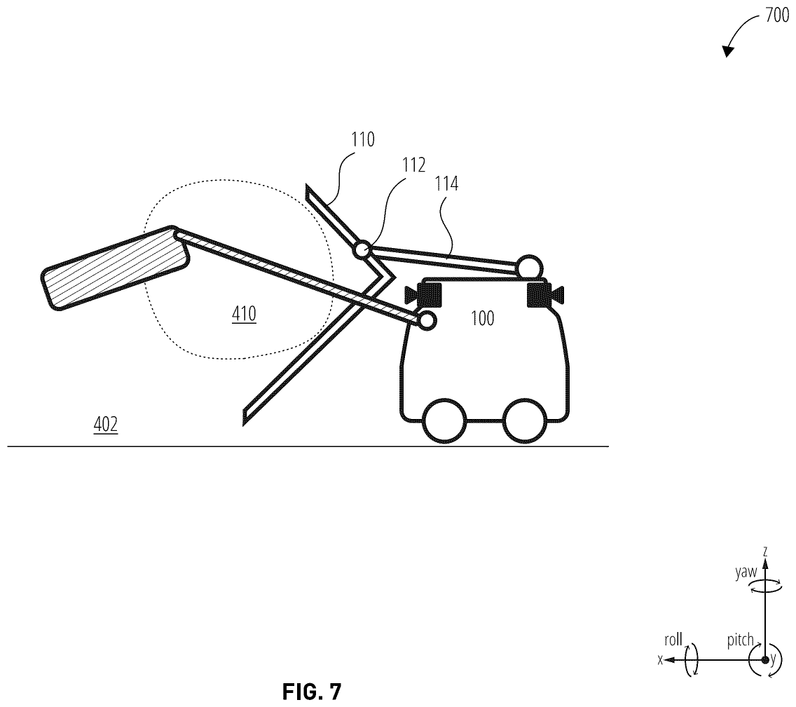

FIG. 7 illustrates a front dump action 800 for the tidying robot 100 in accordance with one embodiment.

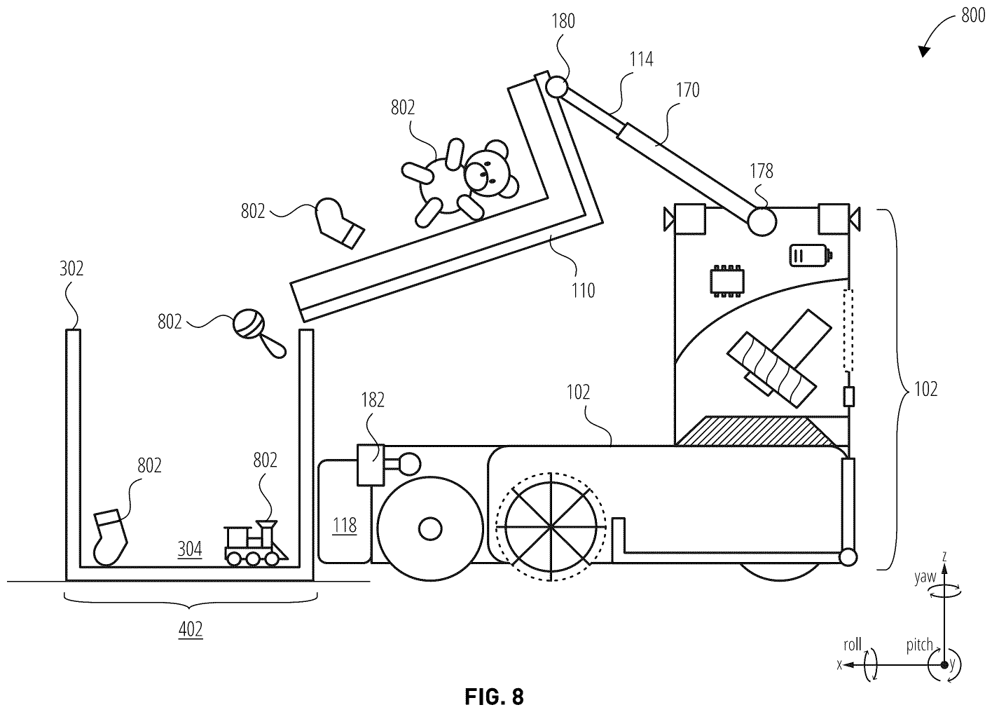

FIG. 8 illustrates a tidying robot 100 performing a front dump in accordance with one embodiment.

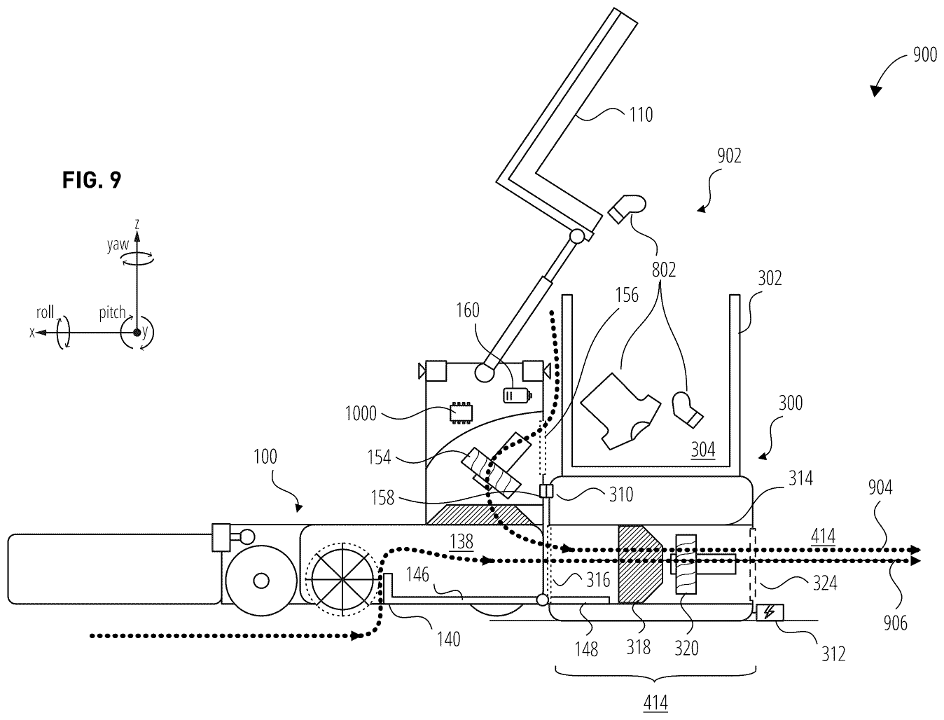

FIG. 9 illustrates a tidying robotic system interaction 900 in accordance with one embodiment.

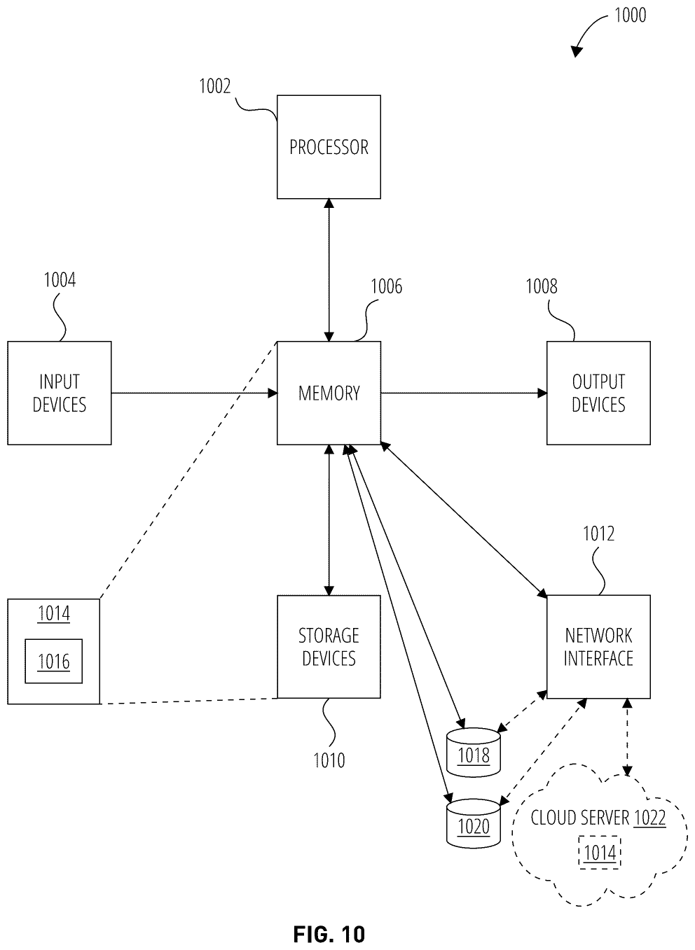

FIG. 10 illustrates an embodiment of a robotic control system 1000 to implement components and process steps of the system described herein.

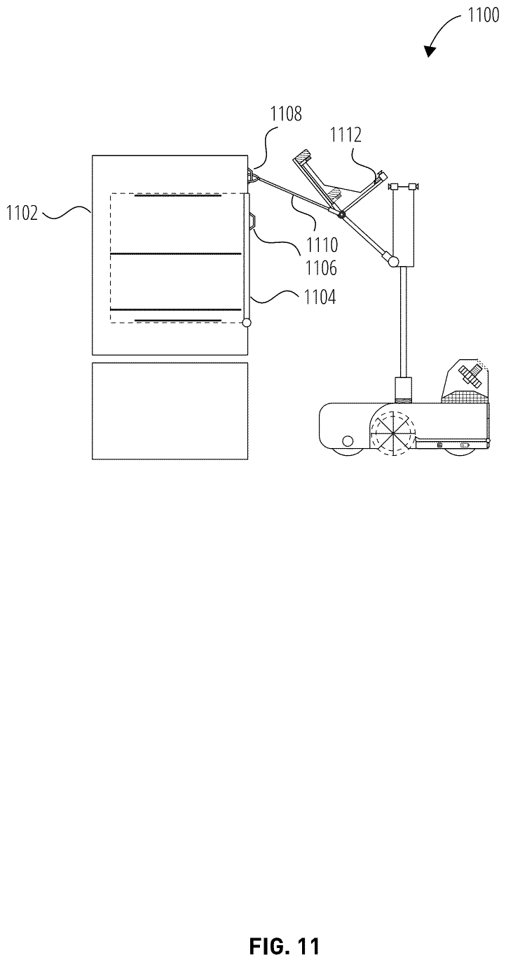

FIG. 11 illustrates an aspect of the subject matter in accordance with one embodiment.

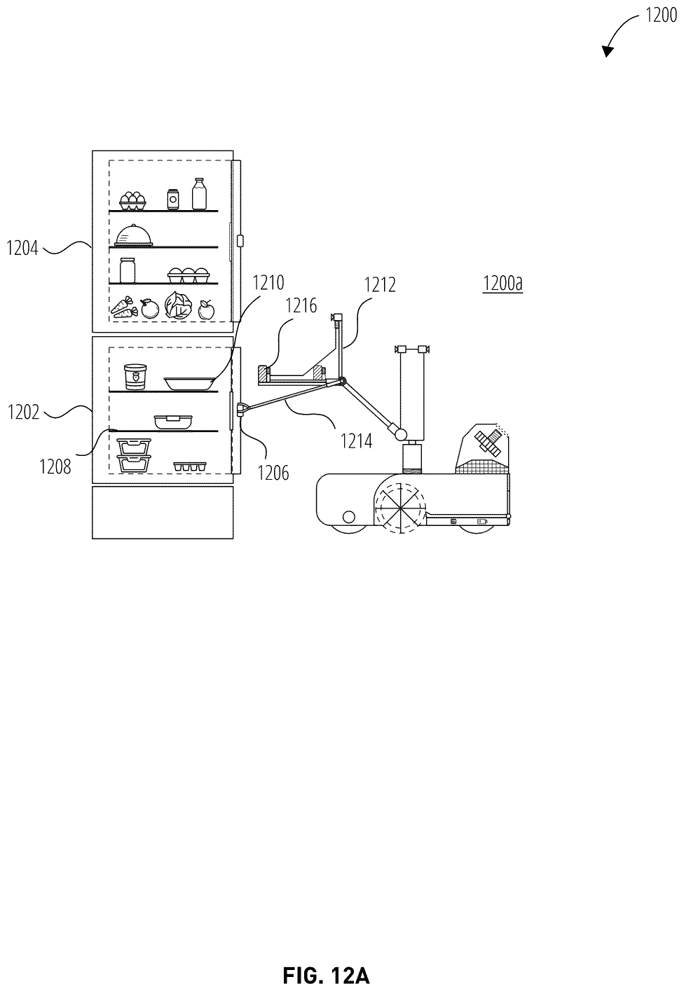

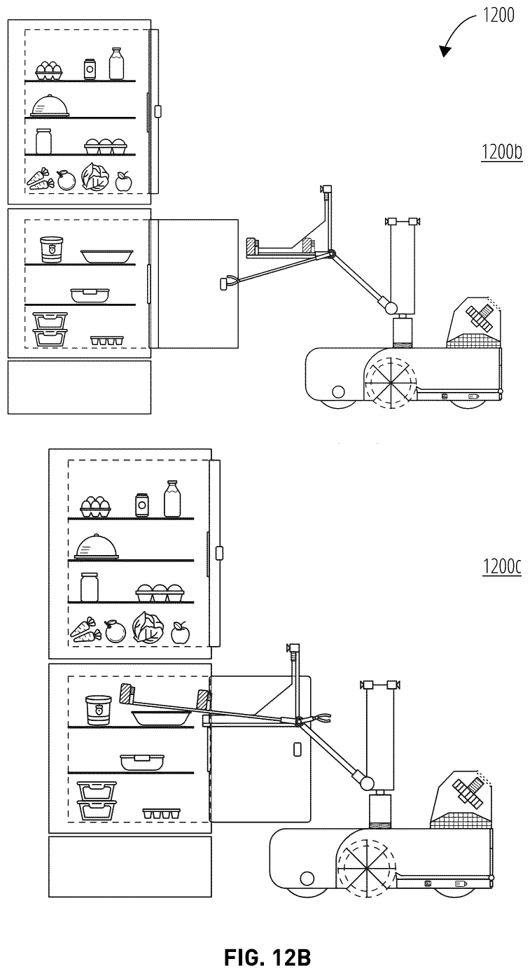

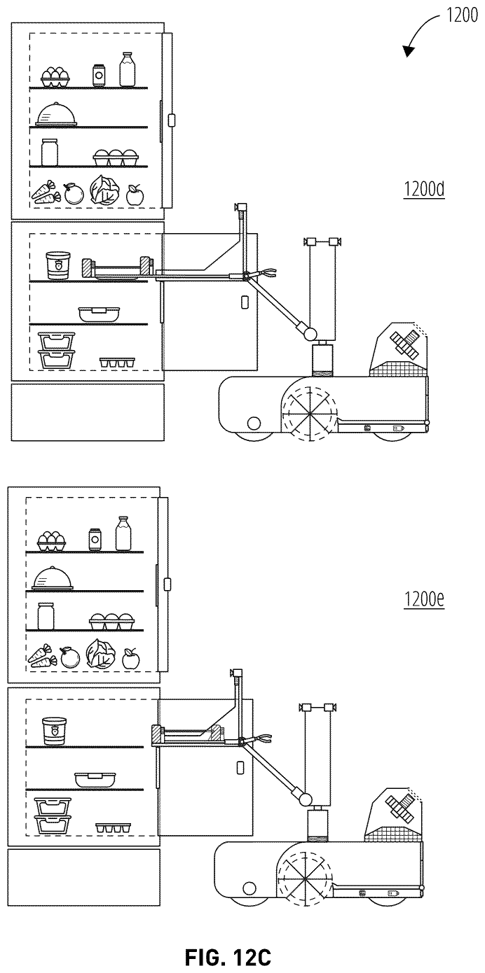

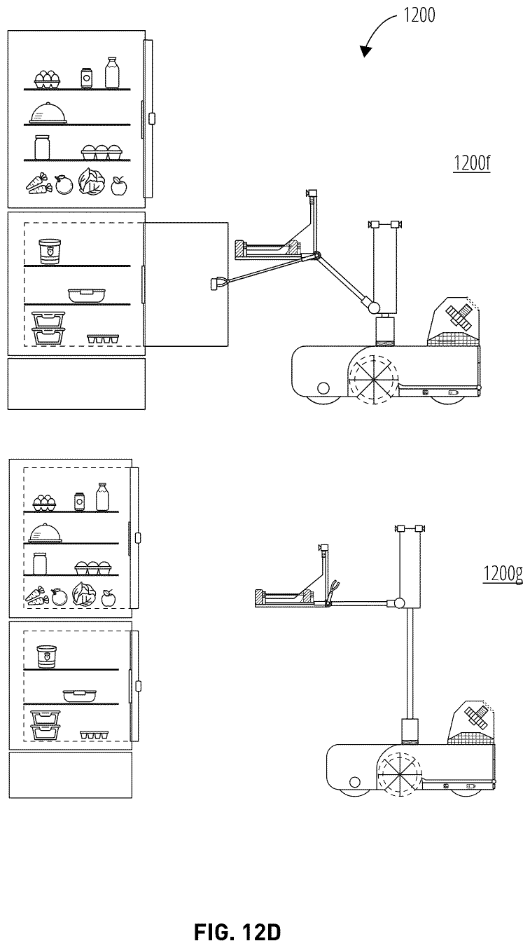

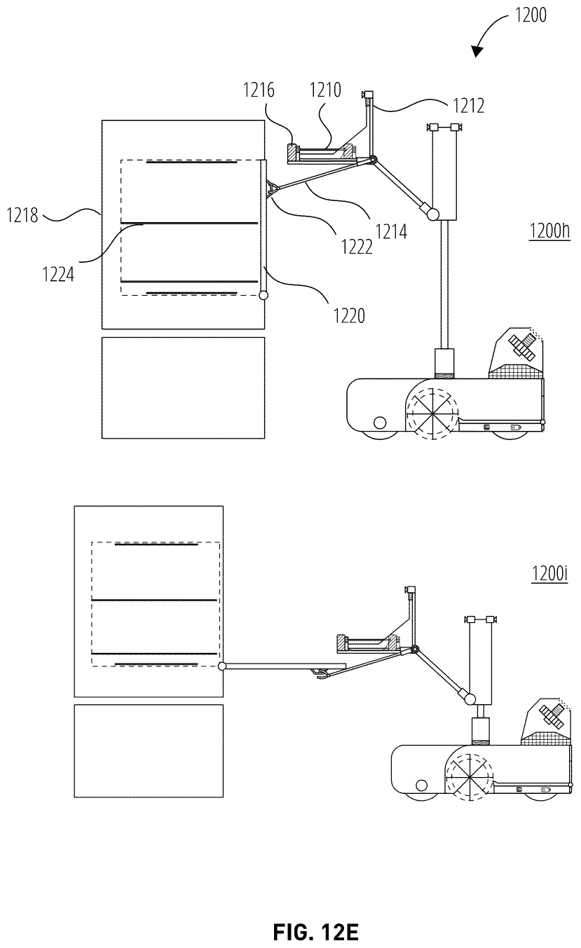

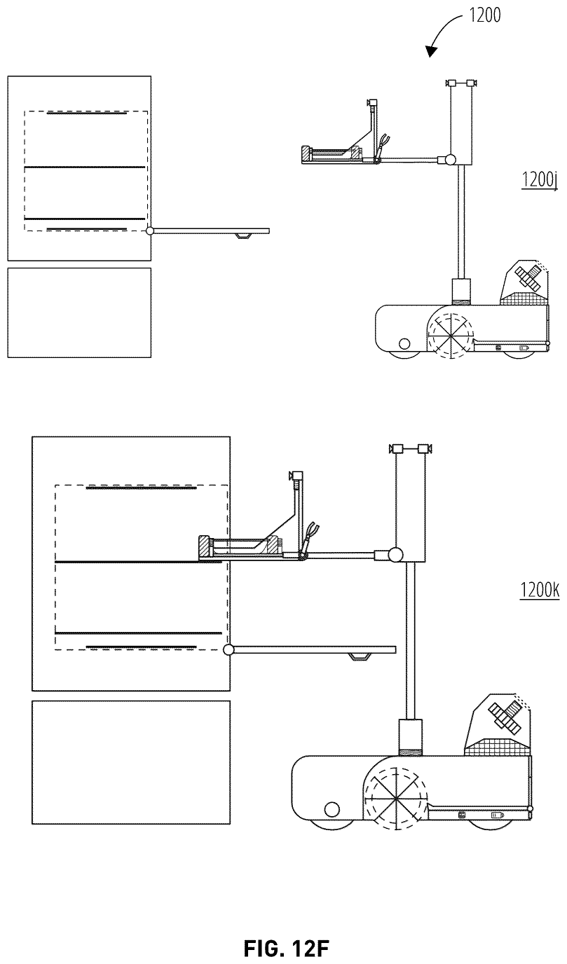

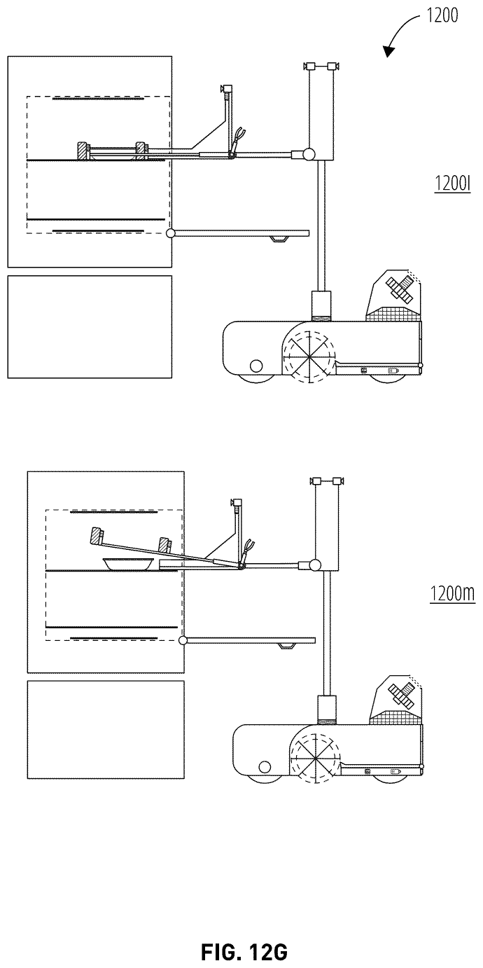

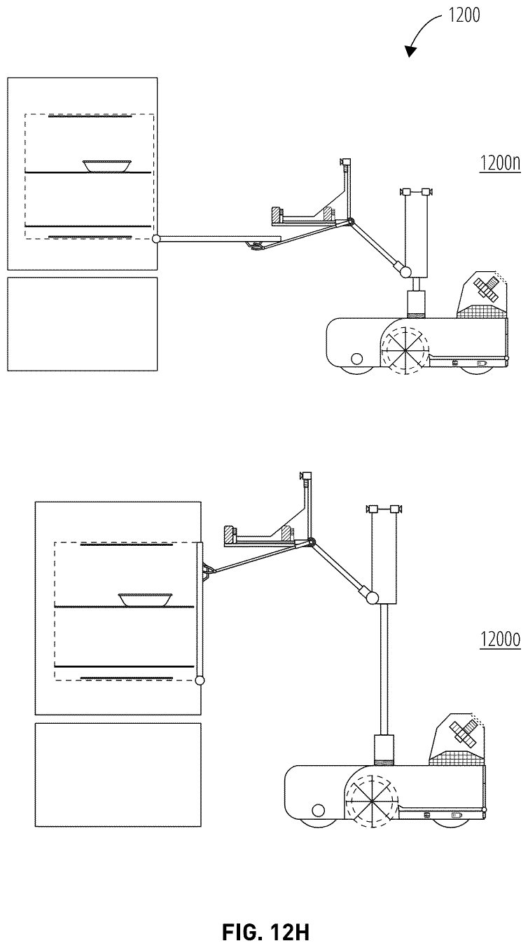

FIG. 12A-FIG. 12H illustrate a method 1200 in accordance with one embodiment.

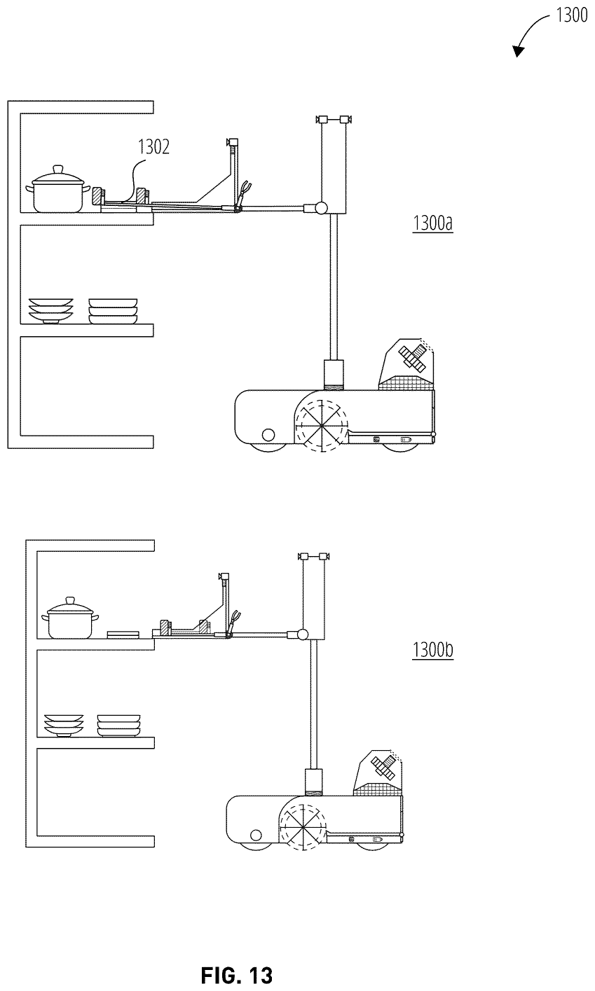

FIG. 13 illustrates a method 1300 in accordance with one embodiment.

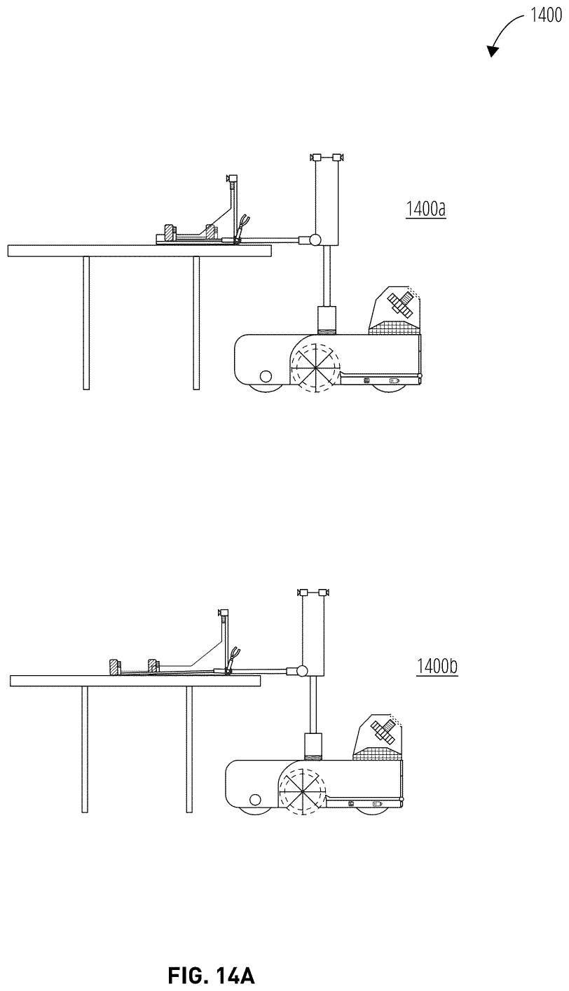

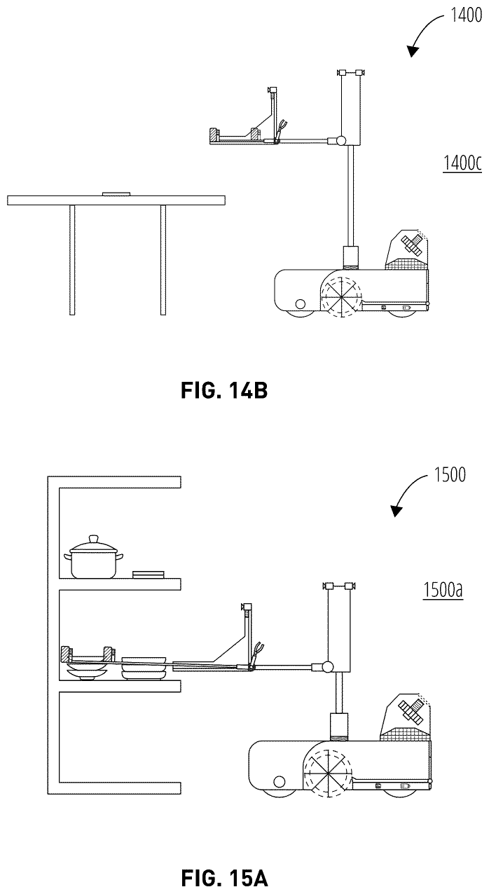

FIG. 14A-FIG. 14B illustrate a method 1400 in accordance with one embodiment.

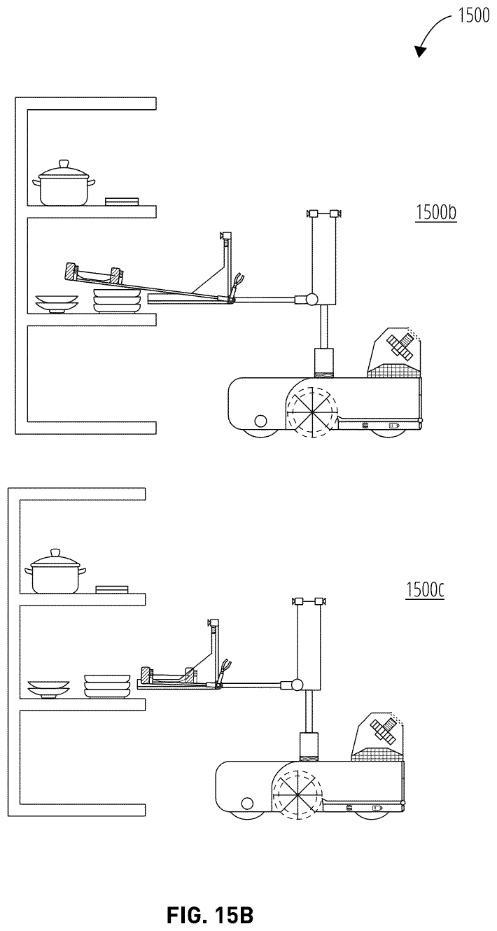

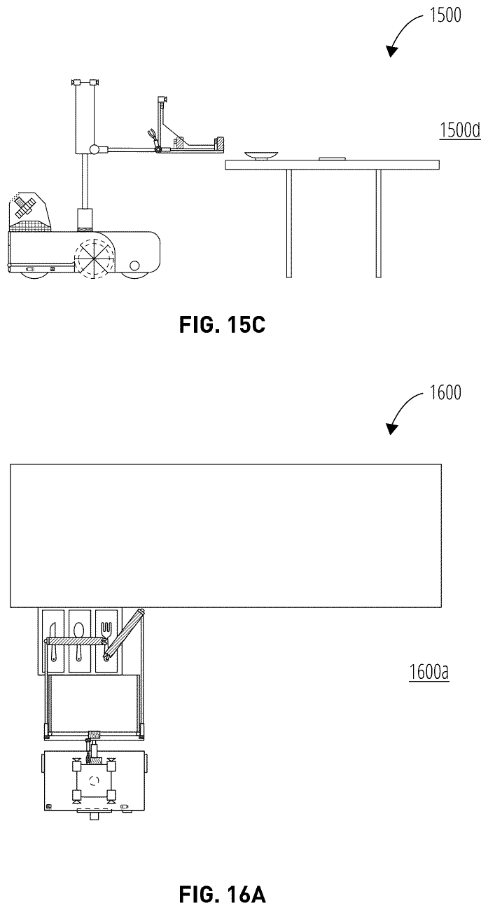

FIG. 15A-FIG. 15C illustrate an aspect of the subject matter in accordance with one embodiment.

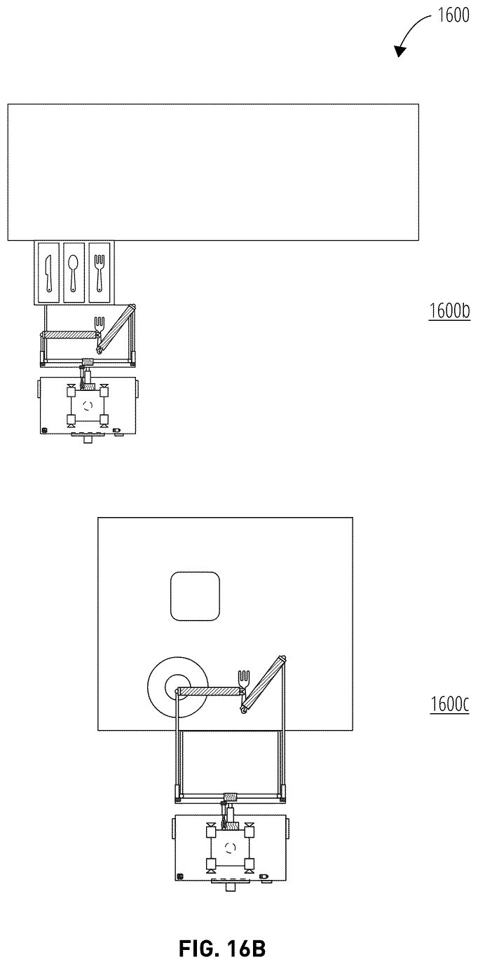

FIG. 16A-FIG. 16B illustrate an aspect of the subject matter in accordance with one embodiment.

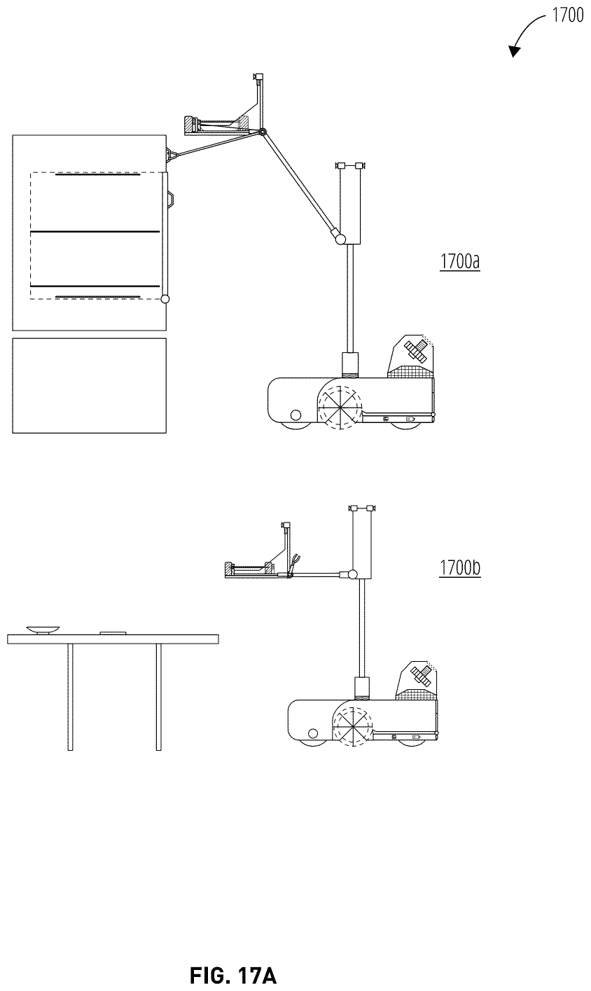

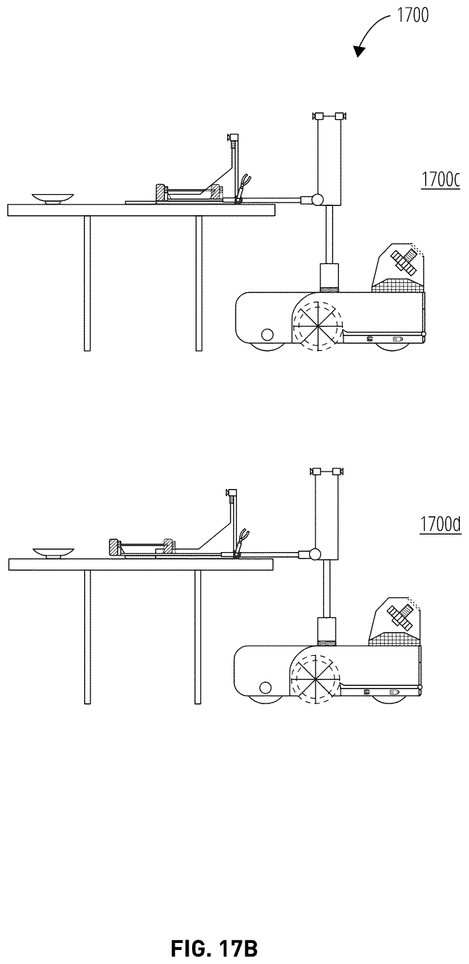

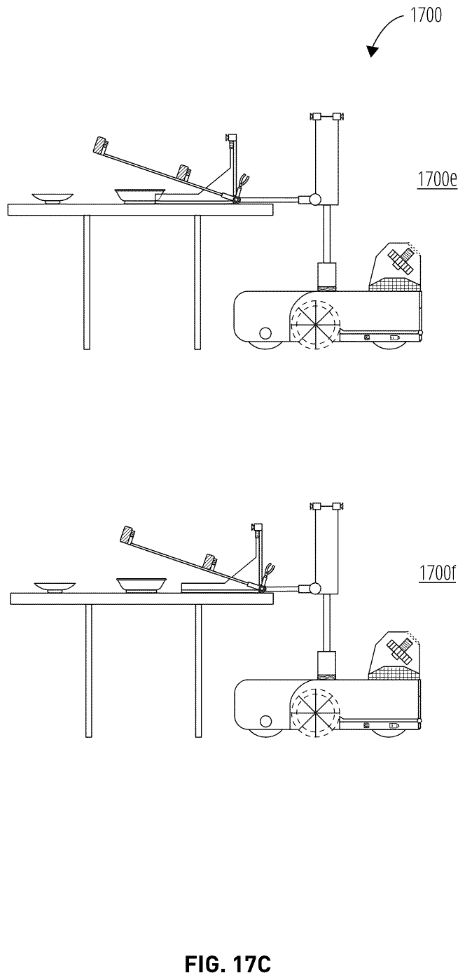

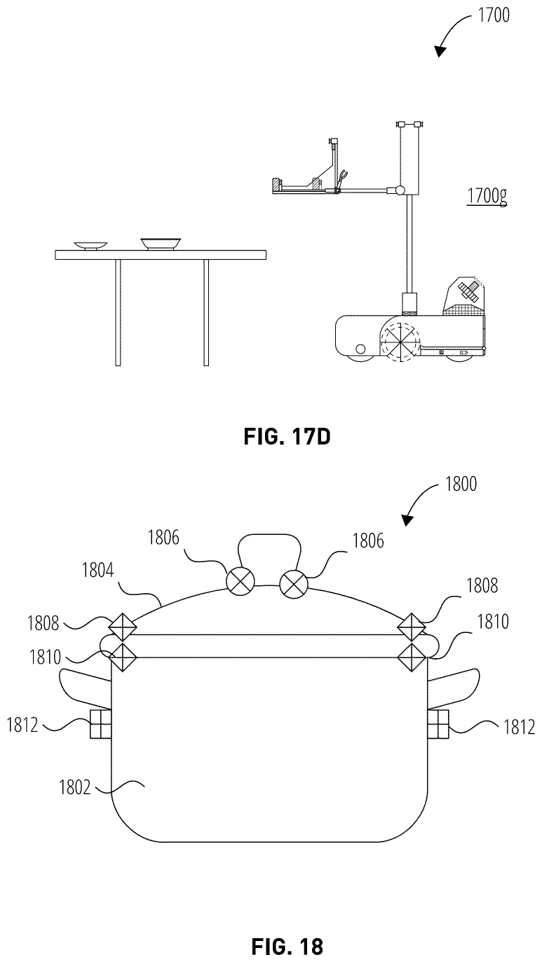

FIG. 17A-FIG. 17D illustrate a method 1700 in accordance with one embodiment.

FIG. 18 illustrates a key point identification 1800 in accordance with one embodiment.

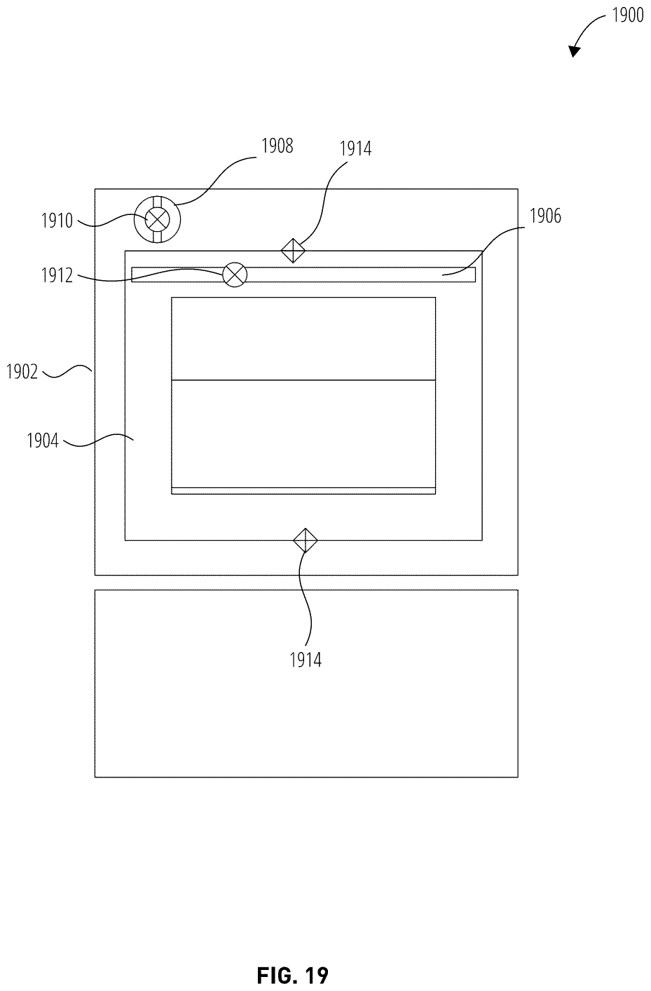

FIG. 19 illustrates a key point identification 1900 in accordance with one embodiment.

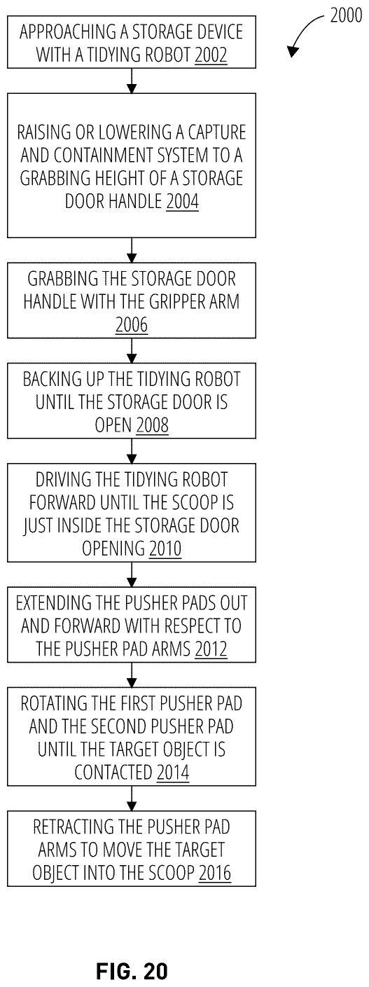

FIG. 20 illustrates a method 2000 in accordance with one embodiment.

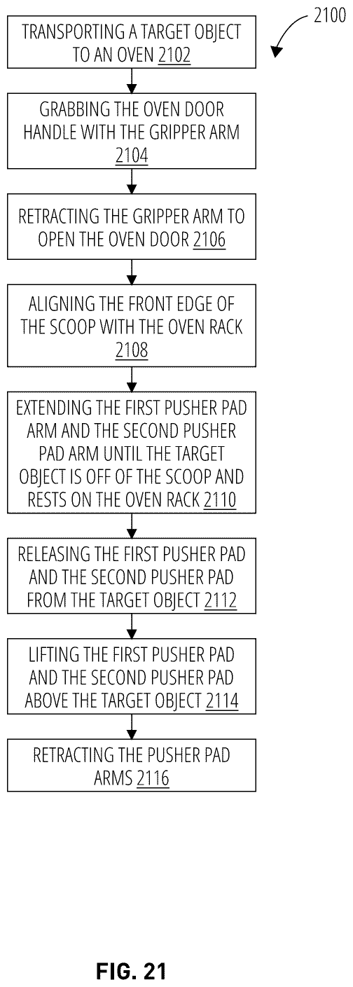

FIG. 21 illustrates a method 2100 in accordance with one embodiment.

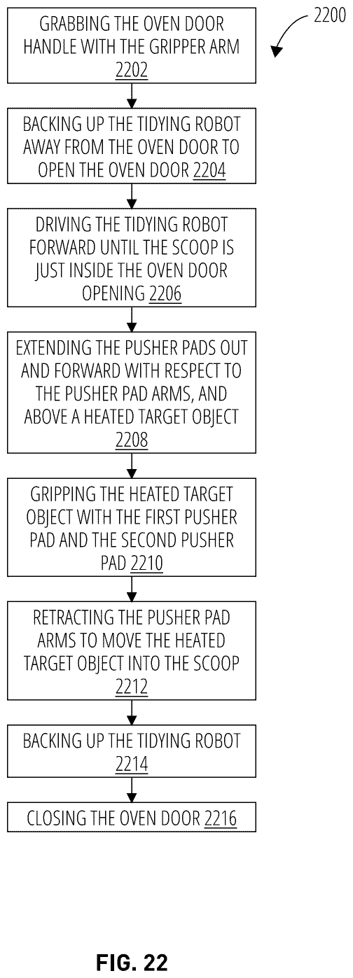

FIG. 22 illustrates a method 2200 in accordance with one embodiment.

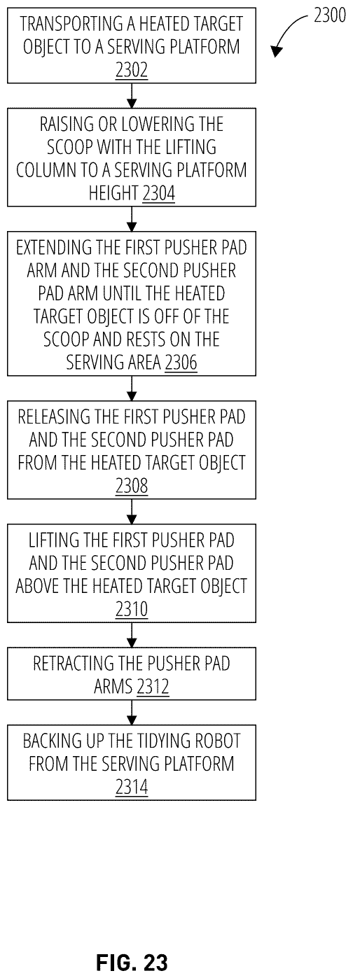

FIG. 23 illustrates a method 2300 in accordance with one embodiment.

### DETAILED DESCRIPTION

A General Purpose Tidying Robot may be configured to set a table before a meal and automatically cook or heat a dished meal in the oven. The tidying robot may have a scoop and pusher pads that are made of insulated and/or heat-resistant materials in order to move dishes into and out of the oven. The tidying robot may have small grippers at the end of each pusher pad which it may use to grab small items such as cutlery out of a drawer in order to set the table. Such grippers may partially or wholly retract into the pusher pads when not in use, then extend out downwards when needed.

FIG. 1A-FIG. 2B illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 1000. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 134, and robot vacuum system 136. The robot vacuum system 136 may include a vacuum compartment 138, a vacuum compartment intake port 140, a cleaning airflow 142, a rotating brush 144, a dirt collector 146, a dirt release latch 148, a vacuum compartment filter 150, and a vacuum generating assembly 152 that includes a vacuum compartment fan 154, a vacuum compartment motor 166, and a vacuum compartment exhaust port 156. The tidying robot 100 may include a robot charge connector 158, a battery 160, and number of motors, actuators, sensors, and mobility components as described in greater detail below, and a robotic control system 1000 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

The chassis 102 may house and protect all or portions of the robotic control system 1000, (portions of which may also be accessed via connection to a cloud server) comprising in some embodiments a processor, memory, and connections to the mobility system 104, sensing system 106, and capture and containment system 108. The chassis 102 may contain other electronic components such as batteries 160, wireless communications 206 devices, etc., as is well understood in the art of robotics. The robotic control system 1000 may function as described in greater detail with respect to FIG. 10. The mobility system 104 and or the robotic control system 1000 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 180 to rotate the scoop 110 into different positions at the scoop pivot point 112. The capture and containment system 108 may also include a scoop arm 114 with an associated scoop arm motor 178 to rotate the scoop arm 114 into different positions around the scoop arm pivot point 116, and a scoop arm linear actuator 170 to extend the scoop arm 114. Pusher pads 118 of the capture and containment system 108 may have pusher pad motors 182 to rotate them into different positions around the pad pivot points 122. Pusher pad arms 120 may be associated with pusher pad arm motors 184 that rotate them around pad arm pivot points 124, as well as pusher pad arm linear actuators 172 to extend and retract the pusher pad arms 120. The gripper arm 128 may include a gripper arm motor 186 to move the gripper arm 128 around a gripper pivot point 130, as well as a gripper arm linear actuator 174 to extend and retract the gripper arm 128. In this manner the gripper arm 128 may be able to move and position itself and/or the actuated gripper 126 to perform the tasks disclosed herein.

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 5A or FIG. 8. It will be well understood by one of ordinary skill in the art that the configurations illustrated may be designed to perform the basic motions described with respect to FIG. 4A-FIG. 9 and the processes illustrated elsewhere herein.

The geometry of the scoop 110 and the disposition of the pusher pads 118 and pusher pad arms 120 with respect to the scoop 110 may describe a containment area, illustrated more clearly in FIG. 4A-FIG. 4E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and grabber positions and raised scoop and grabber positions, as illustrated with respect to FIG. 4A-FIG. 4C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 162 may control the elevation of the capture and containment system 108 by extending and retracting the lifting column 132. A lifting column motor 176 may allow the lifting column 132 to rotate so that the capture and containment system 108 may be moved with respect to the tidying robot 100 base or chassis 102 in all three dimensions.

The tidying robot 100 may include floor cleaning components such as a mop pad 134 and a vacuuming system. The mop pad 134 may be able to raise and lower with respect to the bottom of the tidying robot 100 chassis 102, so that it may be placed in contact with the floor when desired. The mop pad 134 may include a drying element to dry wet spots detected on the floor. In one embodiment, the tidying robot 100 may include a fluid reservoir, which may be in contact with the mop pad 134 and able to dampen the mop pad 134 for cleaning. In one embodiment, the tidying robot 100 may be able to spray cleaning fluid from a fluid reservoir onto the floor in front of or behind the tidying robot 100, which may then be absorbed by the mop pad 134.

The vacuuming system may include a vacuum compartment 138, which may have a vacuum compartment intake port 140 allowing cleaning airflow 142 into the vacuum compartment 138. The vacuum compartment intake port 140 may be configured with a rotating brush 144 to impel dirt and dust into the vacuum compartment 138. Cleaning airflow 142 may be induced to flow by a vacuum compartment fan 154 powered by a vacuum compartment motor 166. cleaning airflow 142 may pass through the vacuum compartment 138 from the vacuum compartment intake port 140 to a vacuum compartment exhaust port 156, exiting the vacuum compartment 138 at the vacuum compartment exhaust port 156. The vacuum compartment exhaust port 156 may be covered by a grating or other element permeable to cleaning airflow 142 but able to prevent the ingress of objects into the chassis 102 of the tidying robot 100.

A vacuum compartment filter 150 may be disposed between the vacuum compartment intake port 140 and the vacuum compartment exhaust port 156. The vacuum compartment filter 150 may prevent dirt and dust from entering and clogging the vacuum compartment fan 154. The vacuum compartment filter 150 may be disposed such that blocked dirt and dust are deposited within a dirt collector 146. The dirt collector 146 may be closed off from the outside of the chassis 102 by a dirt release latch 148. The dirt release latch 148 may be configured to open when the tidying robot 100 is docked at a base station 300 with a vacuum emptying system 314, as is illustrated in FIG. 3A and FIG. 3B and described below. A robot charge connector 158 may connect the tidying robot 100 to a base station charge connector 310, allowing power from the base station 300 to charge the tidying robot 100 battery 160.

FIG. 2A and FIG. 2B illustrate a simplified side view and top view of a chassis 102, respectively, in order to show in more detail aspects of the mobility system 104, the sensing system 106, and the communications 206, in connection with the robotic control system 1000. In some embodiments, the communications 206 may include the network interface 1012 described in greater detail with respect to robotic control system 1000.

In one embodiment, the mobility system 104 may comprise a left front wheel 168b and a right front wheel 168a powered by mobility system motor 164, and a single rear wheel 168c, as illustrated in FIG. 1A and FIG. 1B. The single rear wheel 168c may be actuated or may be a passive roller or caster providing support and reduced friction with no driving force.

In one embodiment, the mobility system 104 may comprise a right front wheel 168a, a left front wheel 168b, a right rear wheel 208, and a left rear wheel 210. The tidying robot 100 may have front-wheel drive, where right front wheel 168a and left front wheel 168b are actively driven by one or more actuators or motors, while the right rear wheel 208 and left rear wheel 210 spin on an axle passively while supporting the rear portion of the chassis 102. In another embodiment, the tidying robot 100 may have rear-wheel drive, where the right rear wheel 208 and left rear wheel 210 are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras such as the front left camera 188a, rear left camera 188b, front right camera 188c, rear right camera 188d, and scoop camera 188e, light detecting and ranging (LIDAR) sensors such as lidar sensors 202, and inertial measurement unit (IMU) sensors, such as IMU sensors 204. In some embodiments, there may be a single front camera and a single rear camera.

FIG. 3A and FIG. 3B illustrate a base station 300 in accordance with one embodiment. FIG. 3A shows a left side view and FIG. 3B shows a top view. The base station 300 may comprise an object collection bin 302 with a storage compartment 304 to hold tidyable objects, heavy dirt and debris, or other obstructions. The storage compartment 304 may be formed by bin sides 306 and a bin base 308. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 300 may further comprise a base station charge connector 310, a power source connection 312, and a vacuum emptying system 314 including a vacuum emptying system intake port 316, a vacuum emptying system filter bag 318, a vacuum emptying system fan 320, a vacuum emptying system motor 322, and a vacuum emptying system exhaust port 324.

The object collection bin 302 may be configured on top of the base station 300 so that a tidying robot 100 may deposit objects from the scoop 110 into the object collection bin 302. The base station charge connector 310 may be electrically coupled to the power source connection 312. The power source connection 312 may be a cable connector configured to couple through a cable to an alternating current (AC) or direct current (DC) source, a battery, or a wireless charging port, as will be readily apprehended by one of ordinary skill in the art. In one embodiment, the power source connection 312 is a cable and male connector configured to couple with 120V AC power, such as may be provided by a conventional U.S. home power outlet.

The vacuum emptying system 314 may include a vacuum emptying system intake port 316 allowing vacuum emptying airflow 326 into the vacuum emptying system 314. The vacuum emptying system intake port 316 may be configured with a flap or other component to protect the interior of the vacuum emptying system 314 when a tidying robot 100 is not docked. A vacuum emptying system filter bag 318 may be disposed between the vacuum emptying system intake port 316 and a vacuum emptying system fan 320 to catch dust and dirt carried by the vacuum emptying airflow 326 into the vacuum emptying system 314. The vacuum emptying system fan 320 may be powered by a vacuum emptying system motor 322. The vacuum emptying system fan 320 may pull the vacuum emptying airflow 326 from the vacuum emptying system intake port 316 to the vacuum emptying system exhaust port 324, which may be configured to allow the vacuum emptying airflow 326 to exit the vacuum emptying system 314. The vacuum emptying system exhaust port 324 may be covered with a grid to protect the interior of the vacuum emptying system 314.

FIG. 4A illustrates a tidying robot 100 such as that introduced with respect to FIG. 1A disposed in a lowered scoop position and lowered pusher position 400a. In this configuration, the pusher pads 118 and pusher pad arms 120 rest in a lowered pusher position 404, and the scoop 110 and scoop arm 114 rest in a lowered scoop position 406 at the front 402 of the tidying robot 100. In this position, the scoop 110 and pusher pads 118 may roughly describe a containment area 410 as shown.

FIG. 4B illustrates a tidying robot 100 with a lowered scoop position and raised pusher position 400b. Through the action of servos or other actuators at the pad pivot points 122 and pad arm pivot points 124, the pusher pads 118 and pusher pad arms 120 may be raised to a raised pusher position 408 while the scoop 110 and scoop arm 114 maintain a lowered scoop position 406. In this configuration, the pusher pads 118 and scoop 110 may roughly describe a containment area 410 as shown, in which an object taller than the scoop 110 height may rest within the scoop 110 and be held in place through pressure exerted by the pusher pads 118.

Pad arm pivot points 124, pad pivot points 122, scoop arm pivot points 116 and scoop pivot points 112 (as shown in FIG. 7) may provide the tidying robot 100 a range of motion of these components beyond what is illustrated herein. The positions shown in the disclosed figures are illustrative and not meant to indicate the limits of the robot's component range of motion.

FIG. 4C illustrates a tidying robot 100 with a raised scoop position and raised pusher position 400c. The pusher pads 118 and pusher pad arms 120 may be in a raised pusher position 408 while the scoop 110 and scoop arm 114 are in a raised scoop position 412. In this position, the tidying robot 100 may be able to allow objects drop from the scoop 110 and pusher pad arms 120 to an area at the rear 414 of the tidying robot 100.

The carrying position may involve the disposition of the pusher pads 118, pusher pad arms 120, scoop 110, and scoop arm 114, in relative configurations between the extremes of lowered scoop position and lowered pusher position 400a and raised scoop position and raised pusher position 400c.

FIG. 4D illustrates a tidying robot 100 with pusher pads extended 400d. By the action of servos or other actuators at the pad pivot points 122, the pusher pads 118 may be configured as extended pusher pads 416 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 4E illustrates a tidying robot 100 with pusher pads retracted 400e. The closed pusher pads 418 may roughly define a containment area 410 through their position with respect to the scoop 110. In some embodiments, the pusher pads 118 may be able to rotate farther than shown, through almost three hundred and sixty degrees, to rest parallel with and inside of the side walls of the scoop 110.

FIG. 5A-FIG. 5C illustrate a tidying robot 100 such as that introduced with respect to FIG. 1A. In such an embodiment, the pusher pad arms 120 may be controlled by a servo or other actuator at the same point of connection 502 with the chassis 102 as the scoop arms 114. The tidying robot 100 may be seen disposed in a lowered scoop position and lowered pusher position 500a, a lowered scoop position and raised pusher position 500b, and a raised scoop position and raised pusher position 500c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

FIG. 6A-FIG. 6C illustrate a tidying robot 100 such as that introduced with respect to FIG. 1A. In such an embodiment, the pusher pad arms 120 may be controlled by a servo or servos (or other actuators) at different points of connection 602 with the chassis 102 from those controlling the scoop arm 114. The tidying robot 100 may be seen disposed in a lowered scoop position and lowered pusher position 600a, a lowered scoop position and raised pusher position 600b, and a raised scoop position and raised pusher position 600c. This tidying robot 100 may be configured to perform the algorithms disclosed herein.

The different points of connection 602 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 7 illustrates a tidying robot 100 such as was previously introduced in a front drop position 700. The arms of the tidying robot 100 may be positioned to form a containment area 410 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 410 to slide out and be deposited in an area to the front 402 of the tidying robot 100.

FIG. 8 illustrates how the positions of the components of the tidying robot 100 may be configured such that the tidying robot 100 may approach an object collection bin 302 and perform a front dump action 800. The scoop 110 may be raised by scoop arm motor 178, extended by scoop arm linear actuator 170, and tilted by scoop motor 180 so that tidyable objects 802 carried in the scoop 110 may be deposited into the storage compartment 304 of the object collection bin 302 positioned to the front 402 of the tidying robot 100, as is also described with respect to the front drop position 700 of FIG. 7.

FIG. 9 illustrates a tidying robotic system interaction 900 in accordance with one embodiment. The tidying robotic system may include the tidying robot 100, the base station 300, a robotic control system 1000, and logic 1014 that when executed directs the robot to perform the disclosed method. When the tidying robot 100 is docked at a base station 300 having an object collection bin 302, the scoop 110 may be raised and rotated up and over the tidying robot 100 chassis 102, allowing tidyable objects 802 in the scoop 110 to drop into the storage compartment 304 of the object collection bin 302 to the rear 414 of the tidying robot 100 in a rear dump action 902, as is also described with respect to the raised scoop position and raised pusher position 400c and raised scoop position and raised pusher position 500c described with respect to FIG. 4C and FIG. 5C, respectively.

In a docked state, the robot charge connector 158 may electrically couple with the base station charge connector 310 such that electrical power from the power source connection 312 may be carried to the battery 160, and the battery 160 may be recharged toward its maximum capacity for future use.

When the tidying robot 100 docks at its base station 300, the dirt release latch 148 may lower, allowing the vacuum compartment 138 to interface with the vacuum emptying system 314. Where the vacuum emptying system intake port 316 is covered by a protective element, the dirt release latch 148 may interface with that element to open the vacuum emptying system intake port 316 when the tidying robot 100 is docked. The vacuum compartment fan 154 may remain inactive or may reverse direction, permitting or compelling airflow 904 through the vacuum compartment exhaust port 156, into the vacuum compartment 138, across the dirt collector 146, over the dirt release latch 148, into the vacuum emptying system intake port 316, through the vacuum emptying system filter bag 318, and out the vacuum emptying system exhaust port 324, in conjunction with the operation of the vacuum emptying system fan 320. The action of the vacuum emptying system fan 320 may also pull airflow 906 in from the vacuum compartment intake port 140, across the dirt collector 146, over the dirt release latch 148, into the vacuum emptying system intake port 316, through the vacuum emptying system filter bag 318, and out the vacuum emptying system exhaust port 324. In combination, airflow 904 and airflow 906 may pull dirt and dust from the dirt collector 146 into the vacuum emptying system filter bag 318, emptying the dirt collector 146 for future vacuuming tasks. The vacuum emptying system filter bag 318 may be manually discarded and replaced on a regular basis.

FIG. 10 depicts an embodiment of a robotic control system 1000 to implement components and process steps of the systems described herein. Some or all portions of the robotic control system 1000 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 1000 on a cloud server and/or user's mobile computing device may control more than one robot at a time, allowing multiple robots to work in concert within a working space.

Input devices 1004 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 1004 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1004 are provided via various machine signal conductors (e.g., busses or network interfaces) and circuits to memory 1006.

The memory 1006 is typically what is known as a first-or second-level memory device, providing for storage (via configuration of matter or states of matter) of signals received from the input devices 1004, instructions and information for controlling operation of the central processing unit or processor 1002, and signals from storage devices 1010. The memory 1006 and/or the storage devices 1010 may store computer-executable instructions and thus forming logic 1014 that when applied to and executed by the processor 1002 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 1014 may include portions of a computer program, along with configuration data, that are run by the processor 1002 or another processor. Logic 1014 may include one or more machine learning models 1016 used to perform the disclosed actions. In one embodiment, portions of the logic 1014 may also reside on a mobile or desktop computing device accessible by a user to facilitate direct user control of the robot.

Information stored in the memory 1006 is typically directly accessible to the processor 1002 of the device. Signals input to the device cause the reconfiguration of the internal material/energy state of the memory 1006, creating in essence a new machine configuration, influencing the behavior of the robotic control system 1000 by configuring the processor 1002 with control signals (instructions) and data provided in conjunction with the control signals.

Second-or third-level storage devices 1010 may provide a slower but higher capacity machine memory capability. Examples of storage devices 1010 are hard disks, optical disks, large-capacity flash memories or other non-volatile memory technologies, and magnetic memories.

In one embodiment, memory 1006 may include virtual storage accessible through a connection with a cloud server using the network interface 1012, as described below. In such embodiments, some or all of the logic 1014 may be stored and processed remotely.

The processor 1002 may cause the configuration of the memory 1006 to be altered by signals in storage devices 1010. In other words, the processor 1002 may cause data and instructions to be read from storage devices 1010 in the memory 1006 which may then influence the operations of processor 1002 as instructions and data signals, and which may also be provided to the output devices 1008. The processor 1002 may alter the content of the memory 1006 by signaling to a machine interface of memory 1006 to alter the internal configuration and then converted signals to the storage devices 1010 alter its material internal configuration. In other words, data and instructions may be backed up from memory 1006, which is often volatile, to storage devices 1010, which are often non-volatile.

Output devices 1008 are transducers that convert signals received from the memory 1006 into physical phenomena such as vibrations in the air, patterns of light on a machine display, vibrations (i.e., haptic devices), or patterns of ink or other materials (i.e., printers and 3-D printers).

The network interface 1012 receives signals from the memory 1006 and converts them into electrical, optical, or wireless signals to other machines, typically via a machine network. The network interface 1012 also receives signals from the machine network and converts them into electrical, optical, or wireless signals to the memory 1006. The network interface 1012 may allow a robot to communicate with a cloud server 1022 containing logic 1014, a mobile device, other robots, and other network-enabled devices.

In one embodiment, a global database 1018 may provide data storage available across the devices that comprise or are supported by the robotic control system 1000. The global database 1018 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 1018 may be a single data structure or may be distributed across more than one data structure and storage platform, as may best suit an implementation of the disclosed solution. In one embodiment, the global database 1018 is coupled to other components of the robotic control system 1000 through a wired or wireless network, and in communication with the network interface 1012.

In one embodiment, a robot instruction database 1020 may provide data storage available across the devices that comprise or are supported by the robotic control system 1000. The robot instruction database 1020 may include the programmatic routines that direct specific actuators of the tidying robot, such as are described previously, to actuate and cease actuation in sequences that allow the tidying robot to perform individual and aggregate motions to complete tasks.

FIG. 11 illustrates a method 1100 in accordance with some embodiments. In one embodiment, the general purpose tidying robot is tasked with cooking and serving a frozen meal. The first action the robot undertakes is turning on the oven 1102 to start a preheating process of an oven. In some embodiments, the oven may be a microwave oven and the preheating process may not be necessary. In an embodiment, the face of the oven includes an oven door 1104 with an oven door handle 1106. There may also be a power and temperature control 1108 knob, button, or interface to turn on the oven and turn off the oven. Alternatively, the tidying robot may communicate wirelessly with the oven to perform the actions of the power and temperature control 1108. The tidying robot may utilize a gripper arm 1110 to manipulate the power and temperature control 1108. In some embodiments, the robot may use pushing, swiping, or rotating gestures with the gripper arm to at least one of turn on the oven, adjust a temperature of the oven, select an oven cooking cycle (e.g., broil, roast, bake, etc.), set a timer, and turn off the oven, but the controls are not limited thereto. In the embodiment shown in FIG. 11, the tidying robot tilted back the scoop 1112 before reaching for the power and temperature control 1108 knob. The ability to tilt the scoop 1112 out of the way of the gripper arm 1110 was available because there is no unsecured item in the scoop 1112. See FIG. 17A for an example of the gripper arm 1110 adjusting the power and temperature control 1108 when there is an unsecured item (i.e., food on a plate) in the scoop 1112.

FIG. 12A-FIG. 12H illustrate a method 1200 in accordance with several embodiments, of removing a frozen meal 1210 in a cooking container from a freezer 1202 and heating it in an oven 1218. Even though a frozen meal 1210 and freezer 1202 are used in this example, other examples could include removing a refrigerated meal from a refrigerator 1204 and heating it in the oven 1218, but are not limited thereto.

In an illustrative embodiment, the method 1200 includes, in step 1200a, grabbing a door handle on a freezer door with a gripper arm of a tidying robot, and opening the freezer door with the gripper arm of a tidying robot as seen in step 1200b. The tidying robot moves the scoop and pusher arms inside of the freezer to grab the frozen meal 1210 as shown in step 1200c. In some embodiments, the frozen meal is in a cooking container, such as a glass bowl. In some embodiments, the frozen meal may be on a plate or a cooking tray that is heat safe. The pusher pads may be slightly above the frozen meal 1210 and spread apart to a width enabling them to grab the frozen meal 1210. In step 1200d, the pusher pads are lowered and rotated toward the frozen meal 1210, grabbing the frozen meal 1210. In step 1200e, the pusher pads are retracted into the scoop with the frozen meal 1210. As shown in step 1200f, the tidying robot is backed up from the freezer 1202 and grabs the freezer door handle. In step 1200g, the robot closes the freezer door and backs away from the freezer.

In some embodiments, the tidying robot may turn on the oven using techniques discussed in describing FIG. 11, to start a preheating operation.

After transporting the frozen meal 1210 to the oven, the tidying robot may grasp the oven door handle 1222, in step 1200h, with the gripper arm 1214 and open the oven door 1220 by backing up the tidying robot while lowering the lifting column of the tidying robot as seen in step 1200i. The tidying robot raises the lifting column in step 1200j to the height of the oven rack 1224, and drives forward to align the scoop with the oven rack 1224 in step 1200k. In some embodiments, the scoop and pusher arms are constructed out of insulated materials that can withstand the oven heat and avoid any fire risk. At step 1200l, the pusher pads are extended into the oven to move the frozen meal 1210 from the scoop onto the oven rack 1224. In some embodiments, step 1200l allows the frozen meal 1210 to be safely moved without the risk of being dropped. Next, in step 1200m, the pusher pads release the frozen meal 1210 and are lifted up from the meal and retracted toward the scoop. The scoop is removed from the oven by backing up the tidying robot. In step 1200n, the gripper arm grabs the oven door handle 1222, and the lifting column is raised in step 1200o to close the oven door. In some embodiments, the tidying robot may initiate a timer, as discussed when describing FIG. 11. In some embodiments, the tidying robot may remember time when frozen meal was placed in oven by starting an internal timer to track when the meal will be ready.

FIG. 13 illustrates a method 1300 of removing a hot pad 1302 from a storage shelf in accordance with one embodiment. This method is not limited to hot pads, and may be used for other items such as dishes, and cooking pots and pans. In step 1300a, the scoop of the tidying robot is raised or lowed to the storage shelf height, and the shelf is aligned with a hot pad. In an embodiment, accurate alignment may be needed to grab the top hot pad from a stack of hot pads. The pusher pad arms are extended, while spread apart, to the stack of hot pads 1302. After slightly lowering the pusher pads, they are rotated to grab a single hot pad. In step 1300b, the pusher pads are retracted into the scoop for transport.

FIG. 14A-FIG. 14B illustrate a method 1400 of placing a hot pad onto a serving platform in accordance with one embodiment, but is not only limited to hot pads as discussed above with FIG. 13. Not all serving platforms require a hot pad to protect the surface from a hot object. These heat resistant surfaces may be made of items like stone, metal, composite materials, etc. After the hot pad has been transported to the serving platform, the scoop is raised to the height of the serving platform and moved onto the platform as seen in step 1400a. The serving platform may be a table, a countertop, a bar, or any surface on which food may be consumed. In step 1400b, the pusher arms are extended to a serving area on the platform, and the hot pad is released from the pusher arms. In step 1400c, the scoop has been lifted from the serving platform to a transporting height.

FIG. 15A-FIG. 15C illustrate a method 1500 of removing a serving object, such as a plate, from where it is stored, such as on a shelf or in a cupboard. In step 1500a, the tidying robot approaches the storage location and raises or lowers the scoop to a grabbing height of the serving object. The tidying robot is then driven forward until the capture and containment system, which includes the scoop, pusher pads and pusher pad arms, can engage with the serving object. The pusher pads are extended out and forward with respect to the pusher pad arms, and above the serving object. The first pusher pad is rotated inward toward a front edge of the scoop in a position to grasp a first side of the serving object, followed by rotating the second pusher pad until the second pusher pad is in the position to grasp a second side of the serving object. The tidying robot approaches the serving object and comes to a stop when the serving object is positioned below and between the pusher pads, after which the pusher pads are lowered to the height of the serving object. Next, the first pusher pad and the second pusher pad are rotated until the serving object is contacted, and then the serving object is grasped with the pusher pads. In step 1500b, if the serving object will contact an obstruction if the pusher pads are retracted toward the scoop, the pusher pads grasping the serving object are raised above the obstruction. Next, in step 1500c, the pusher pad arms are retracted to move the serving object into the scoop, followed by backing up the tidying robot to remove the capture and containment system from the storage area and raising or lowering the capture and containment system to a transporting height. The serving object is then delivered to a serving platform and placed on the serving platform as seen in step 1500d and in method 1600 discussed below.

FIG. 16A-FIG. 16B illustrate a method 1600 in accordance with one embodiment for delivering cutlery items to a serving platform. An individual cutlery item may be obtained by the tidying robot using the processes discussed in method 1500, where the cutlery item is gripped with pinch grippers, the storage area is a drawer or a cutlery tray, the serving object is a cutlery item, and the pusher pads include the pinch grippers on tips of the pusher pads, as seen in step 1600a. After the gripped cutlery item has been moved into the scoop by retracting the pusher pads with pinch grippers securing the cutlery item, as seen in step 1600b, the cutlery item is transported to a serving platform. The scoop may be raised or lowered with the lifting column to the serving platform height, and positioned to align the scoop with a serving area on the serving platform. As seen in step 1600c, the first pusher pad arm and the second pusher pad arm may be extended until the serving object is off of the scoop and rests on the serving area, followed by releasing the first pusher pad and the second pusher pad from the serving object, thereby depositing the serving object on the serving platform. In some embodiments, the first pusher pad and the second pusher pad are then lifted above the serving object and the pusher pad arms are retracted into the scoop before the tidying robot is moved away from the serving platform.

FIG. 17A-FIG. 17D illustrate a method 1700 of transporting a cooked meal from an oven to a serving area according to some embodiments. In step 1700a, a tidying robot holding the cooked meal, in a cooking container including a heated food item, in the scoop turns off the oven using a gripper arm. The scoop may need to remain level it contains food that is not secured in a way to prevent spills caused by tilting the scoop. In some embodiments, the scoop is above the height of the control knob on the oven so that the gripper arm can operate the knob from under the scoop without tilting the scoop. In step 1700b, the cooked meal is transported to a serving platform. The scoop may be raised or lowered with the lifting column to the serving platform height, and positioned to align the scoop with a serving area on the serving platform as seen in step 1700c. Next, in step 1700d, the first pusher pad arm and the second pusher pad arm may be extended until the cooked is off of the scoop and rests on the serving area or a hot plate on the serving area. In step 1700e, the first pusher pad and the second pusher pad may be released from the cooked meal and lifted above the cooked meal, followed by moving the scoop away from the serving area, as seen in step 1700f. In some embodiments, the first pusher pad and the second pusher pad are then retracted into the scoop before the tidying robot is moved away from the serving platform as seen in step 1700g.

FIG. 18 illustrates a key point identification 1800 in accordance with carrying a pot in one embodiment.

When manipulating objects with the general purpose tidying robot such as having it fold clothing or opening appliance doors, the robot may often use a deep learning model to generate key points for specifically manipulating certain objects, often alongside panoptic segmentation, which labels both whole objects and their individual parts. In some embodiments, these tasks are commonly handled by a single model with a shared backbone and multiple output heads, such as one for segmentation and another for key point detection, enabling efficient joint inference.

In particular, these manipulation key points may often differ from visual key points in that for example the correct fold points on clothing may often simply be along an edge a certain distance from a corner where the corner is visually distinctive, but the fold point is not visually unique.

### Carrying a Pot

FIG. 18 illustrates the locations useful for carrying a pot 1802 with a lid 1804. Pot lift points 1812 may show where pusher pads of a tidying robot may be placed to lift the pot 1802. In some embodiments, lid grip points 1806 show where the lid 1804 should be grasped to remove it. In another embodiment, the lid alignment points 1808 and pot alignment points 1810 may be used to determine how the lid 1804 may be placed back onto the pot 1802.

FIG. 19 illustrates a key point identification 1900 in accordance with operating an oven door 1904 in one embodiment. The oven 1902 may have an oven door 1904 with an oven door handle 1906 and a control knob 1908. In some embodiments, a control knob point 1910 may show where a gripper arm of the tidying robot may be placed to operate the control knob 1908. In some embodiments, an oven door handle point 1912 may show where the gripper arm may be placed to open and close the oven door 1904. In some embodiments, oven door close points 1914 may allow the motion of the oven door 1904 to be modeled for manipulation since the arc of rotation is known for these key points.

FIG. 20 illustrates an example method 2000 for removing a target item from a storage device. Although the example method 2000 and in the figures and examples below depict a particular sequences of operations, the sequences may be altered without departing from the scope of the present disclosure. For example, some of the operations depicted may be performed in parallel or in a different sequence that does not materially affect the function of the method 2000. In other examples, different components of an example device or system that implements the method 2000 may perform functions at substantially the same time or in a specific sequence.

According to some examples, the method includes approaching a storage device with a tidying robot at block 2002.

According to some examples, the method includes raising or lowering a capture and containment system to a grabbing height of a storage door handle at block 2004.

According to some examples, the method includes grabbing the storage door handle with the gripper arm at block 2006.

According to some examples, the method includes backing up the tidying robot until the storage door is open at block 2008.

According to some examples, the method includes driving the tidying robot forward until the scoop is just inside the storage door opening at block 2010.

According to some examples, the method includes extending the pusher pads out and forward with respect to the pusher pad arms at block 2012.

According to some examples, the method includes rotating the first pusher pad and the second pusher pad until the target object is contacted at block 2014.

According to some examples, the method includes retracting the pusher pad arms to move the target object into the scoop at block 2016.

FIG. 21 illustrates an example method 2100 for transporting an item to an oven.

According to some examples, the method includes transporting a target object to an oven at block 2102.

According to some examples, the method includes grabbing the oven door handle with the gripper arm at block 2104.

According to some examples, the method includes retracting the gripper arm to open the oven door at block 2106.

According to some examples, the method includes aligning the front edge of the scoop with the oven rack at block 2108.

According to some examples, the method includes extending the first pusher pad arm and the second pusher pad arm until the target object is off of the scoop and rests on the oven rack at block 2110.

According to some examples, the method includes releasing the first pusher pad and the second pusher pad from the target object at block 2112.

According to some examples, the method includes lifting the first pusher pad and the second pusher pad above the target object at block 2114.

According to some examples, the method includes retracting the pusher pad arms at block 2116.

FIG. 22 illustrates an example method 2200 for removing an item from an oven.

According to some examples, the method includes grabbing the oven door handle with the gripper arm at block 2202.

According to some examples, the method includes backing up the tidying robot away from the oven door to open the oven door at block 2204.

According to some examples, the method includes driving the tidying robot forward until the scoop is just inside the oven door opening at block 2206.

According to some examples, the method includes extending the pusher pads out and forward with respect to the pusher pad arms, and above a heated target object at block 2208.

According to some examples, the method includes gripping the heated target object with the first pusher pad and the second pusher pad at block 2210.

According to some examples, the method includes retracting the pusher pad arms to move the heated target object into the scoop at block 2212.

According to some examples, the method includes backing up the tidying robot at block 2214.

According to some examples, the method includes closing the oven door at block 2216.

FIG. 23 illustrates an example method 2300 for transporting a cooked item to a serving platform.

According to some examples, the method includes transporting a heated target object to a serving platform at block 2302.

According to some examples, the method includes raising or lowering the scoop with the lifting column to a serving platform height at block 2304.

According to some examples, the method includes extending the first pusher pad arm and the second pusher pad arm until the heated target object is off of the scoop and rests on the serving area at block 2306.

According to some examples, the method includes releasing the first pusher pad and the second pusher pad from the heated target object at block 2308.

According to some examples, the method includes lifting the first pusher pad and the second pusher pad above the heated target object at block 2310.

According to some examples, the method includes retracting the pusher pad arms at block 2312.

According to some examples, the method includes backing up the tidying robot from the serving platform at block 2314.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A method comprising:
approaching a storage device with a tidying robot, wherein the storage device contains a target object, and
wherein the tidying robot is configured with:
a chassis;
a capture and containment system including:
a scoop;
pusher pads including a first pusher pad and a second pusher pad;
pusher pad arms including a first pusher pad arm and a second pusher pad arm;
a gripper arm;
a lifting column configured to raise and lower the capture and containment system through extension and retraction of a lifting column linear actuator;
raising or lowering the capture and containment system, using the lifting column linear actuator to a grabbing height of a storage door handle on a storage door, covering a storage door opening of the storage device;
grabbing the storage door handle with the gripper arm;
backing up the tidying robot until the storage door is open;
driving the tidying robot forward until the scoop is just inside the storage door opening;
extending the pusher pads out and forward with respect to the pusher pad arms, and above the target object;
rotating the first pusher pad inward toward a front edge of the scoop in a position to grasp a first side of the target object;
rotating the second pusher pad until the second pusher pad is in the position to grasp a second side of the target object;
approaching the target object and coming to a stop when the target object is positioned below and between the pusher pads;
lowering the pusher pads to the height of the target object;
rotating the first pusher pad and the second pusher pad until the target object is contacted;
retracting the pusher pad arms to move the target object into the scoop; and
exerting pressure on the target object with the pusher pads to hold the target object stationary in the scoop;
backing up the tidying robot to remove the capture and containment system from the storage device;
grabbing the storage door handle with the gripper arm;
driving the tidying robot forward to close the storage door; and
raising or lowering the capture and containment system to a transporting height.

2. The method of claim 1, further comprising:
transporting the target object to an oven, wherein the oven includes an oven door handle on the oven door for accessing an interior of the oven including an oven rack;
performing at least one of raising and lowering the capture and containment system so that the gripper arm is within reach of the oven door handle;
grabbing the oven door handle with the gripper arm;
retracting the gripper arm and lowering the lifting column while backing up the tidying robot away from the oven door to open the oven door;
raising or lowering the scoop with the lifting column to an oven rack height;
driving the tidying robot forward to align the front edge of the scoop with the oven rack;
extending the first pusher pad arm and the second pusher pad arm until the target object is off of the scoop and rests on the oven rack;
releasing the first pusher pad and the second pusher pad from the target object;
lifting the first pusher pad and the second pusher pad above the target object;
retracting the pusher pad arms;
backing up the tidying robot from the oven door;
grabbing the oven door handle with the gripper arm;
driving the tidying robot forward while raising the lifting column until the oven door is closed; and
releasing the gripper arm from the oven door handle.

3. The method of claim 2, further comprising:
engaging a power and temperature control interface on the oven with the gripper arm;
pushing, swiping, or rotating, with the gripper arm, the power and temperature control interface to at least one of:
turn on the oven;
adjust a temperature of the oven;
select an oven cooking cycle;
set a timer;
turn off the oven; and
releasing the gripper arm from the power and temperature control interface.

4. The method of claim 2, wherein the target object is a cooking container including a food item.

5. The method of claim 3, further comprising:
grabbing the oven door handle with the gripper arm, wherein the oven contains a heated target object;
retracting the gripper arm and lowering the lifting column while backing up the tidying robot away from the oven door to open the oven door;
raising or lowering the scoop with the lifting column to the oven rack height;
driving the tidying robot forward until the scoop is just inside the oven door opening;
extending the pusher pads out and forward with respect to the pusher pad arms, and above the heated target object;
rotating the first pusher pad inward toward the front edge of the scoop in a position to grasp a first side of the heated target object;
rotating the second pusher pad until the second pusher pad is in the position to grasp a second side of the heated target object;
approaching the heated target object and coming to a stop when the heated target object is positioned below and between the pusher pads;
lowering the pusher pads to the height of the heated target object;
rotating the first pusher pad and the second pusher pad until the heated target object is contacted;
retracting the pusher pad arms to move the heated target object into the scoop;
exerting pressure on the heated target object with the pusher pads to hold the heated target object stationary in the scoop;
backing up the tidying robot to remove the capture and containment system from the oven;
grabbing the oven door handle with the gripper arm;
driving the tidying robot forward to close the oven door; and
raising or lowering the capture and containment system to the transporting height.

6. The method of claim 5, wherein the heated target object is a heated cooking container including a heated food item.

7. The method of claim 5, further comprising:
transporting the heated target object to a serving platform;
raising or lowering the scoop with the lifting column to a serving platform height;
driving the tidying robot forward to align the scoop with a serving area on the serving platform;
extending the first pusher pad arm and the second pusher pad arm until the heated target object is off of the scoop and rests on the serving area;
releasing the first pusher pad and the second pusher pad from the heated target object;
lifting the first pusher pad and the second pusher pad above the heated target object;
retracting the pusher pad arms;
backing up the tidying robot from the serving platform;
raising or lowering the capture and containment system to the transporting height.

8. The method of claim 7, further comprising placing the heated target object on a hot pad, wherein the serving area includes the hot pad.

9. A method comprising:
approaching a storage area with a tidying robot, wherein the storage area contains a serving object, and
wherein the tidying robot is configured with:
a chassis;
a capture and containment system including:
a scoop;
pusher pads including a first pusher pad and a second pusher pad;
pusher pad arms including a first pusher pad arm and a second pusher pad arm;
a gripper arm;
a lifting column configured to raise and lower the capture and containment system through extension and retraction of a lifting column linear actuator;
raising or lowering the capture and containment system, using the lifting column linear actuator to a grabbing height of the serving object;
driving the tidying robot forward until the capture and containment system can engage with the serving object;
extending the pusher pads out and forward with respect to the pusher pad arms, and above the serving object;
rotating the first pusher pad inward toward a front edge of the scoop in a position to grasp a first side of the serving object;
rotating the second pusher pad until the second pusher pad is in the position to grasp a second side of the serving object;
approaching the serving object and coming to a stop when the serving object is positioned below and between the pusher pads;
lowering the pusher pads to the height of the serving object;
rotating the first pusher pad and the second pusher pad until the serving object is contacted;
grasping the serving object with the pusher pads;
on condition the serving object will contact an obstruction if the pusher pads are retracted toward the scoop:
raising the pusher pads grasping the serving object;
retracting the pusher pad arms to move the serving object into the scoop; and
backing up the tidying robot to remove the capture and containment system from the storage area; and
raising or lowering the capture and containment system to a transporting height.

10. The method of claim 9, wherein the serving object is at least one of a serving dish and a hot pad.

11. The method of claim 9, further comprising gripping a cutlery item with pinch grippers, wherein,
the storage area is a drawer or a cutlery tray;
the serving object is a cutlery item; and
the pusher pads include the pinch grippers on tips of the pusher pads.

12. The method of claim 9, further comprising:
transporting the serving object in the scoop to a serving platform;
raising or lowering the scoop with the lifting column to a serving platform height;
driving the tidying robot forward to align the scoop with a serving area on the serving platform;
extending the first pusher pad arm and the second pusher pad arm until the serving object is off of the scoop and rests on the serving area;
releasing the first pusher pad and the second pusher pad from the serving object;
lifting the first pusher pad and the second pusher pad above the serving object;
retracting the pusher pad arms;
backing up the tidying robot from the serving platform;
raising or lowering the capture and containment system to the transporting height.

13. The method of claim 12, further comprising gripping a cutlery item with pinch grippers, wherein,
the storage area is a drawer or a cutlery tray;
the serving object is a cutlery item; and
the pusher pads include the pinch grippers on tips of the pusher pads.
